(19) United States
(12) Patent Application Publication
(10) Pub. No.: US 2019/0031313 A1
(43) Pub. Date: Jan. 31, 2019

(54) ELECTROMECHANICAL COMPLEX FOR CONTROLLING A STABILISING FIN FOR A VESSEL

(71) Applicant: CMC MARINE S.r.l., Milano (MI) (IT)

(72) Inventor: Aroldo TRIVELLI, Monza (MB) (IT)

(21) Appl. No.: 16/072,692

(22) PCT Filed: Jan. 24, 2017
(86) PCT No.: PCT/IB2017/050359

§ 371 Date: Jul. 25, 2018

(30) Foreign Application Priority Data
Jan. 25, 2016 (IT) UB2016A000510

(51) Int. Cl. B63H 25/24; F16H 1/32; H02K 5/20; H02K 7/116; B63B 35/79

(52) U.S. Cl. CPC B63H 25/24; F16H 1/32; B63B 35/7926; H02K 7/116; H02K 5/20

(57) ABSTRACT

An electromechanical control complex of small size for a stabilising fin of a vessel, said electromechanical complex comprising, included in a single modular housing, an electric motor with a hollow shaft and a corresponding hollow shaft gearbox capable of driving a shaft of aforesaid fin. This housing is directly cooled by the water in which the vessel lies.

This invention relates to an electromechanical complex for controlling a stabilising fin according to the precharacterising clause of the principal claim.

By non-limiting reference to a “stabilising fin” of a vessel or boat, by such terms are meant a substantially laminar flat structure associated with the lower part of the hull of a vessel and mounted in such a way that it can swing on a shaft dedicated to this purpose which is generally suitably driven and orientated by actuator units or complexes of the hydraulic and electromechanical type to stabilise sailing of the vessel itself and, mainly, rolling when the vessel is at anchor.

In order to perform its specific stabilising function in a satisfactory way said fin requires high motor torques generated by a corresponding electromechanical complex connected to a shaft of the fin.

At the present time known electromechanical complexes give rise to torques which substantially depend directly on the surface area of the stabilising fin itself. Because of this known stabilising fins are generally only fitted to vessels of medium to large size; high torque values are needed to move them and to achieve these high gear ratios are required, which in electromechanical complexes or units of the known art are obtained from at least two stages of a mechanical gearbox, normally of the epicycloidal type, coaxial with the shaft of the fin itself.

Obviously the known two stages placed in succession have large vertical dimensions creating a housing problem, particularly in medium sized boats, because the gearbox unit and the corresponding electrical control motor, which are mounted in vertical sequence from the shaft to the fin respectively, form a bulky complex for operating the fin itself even if a bevel gear is normally used in the coupling between the electric motor and the gearbox to reduce these dimensions.

Complexes of such type are for example described in DE815064, U.S. Pat. No. 5,631,511, EP0388207, DE10350040, WO03/070542, JP2002372110, JP2000120180 and SU509950.

Electromechanical complexes in which the electric motor is placed with the axis of the output shaft at right angles to that of the shaft of the gearbox unit which is in turn axially connected to the shaft of the stabilising fin are also known. This known solution (described in EP2172394) is appreciably complex to construct because of the presence of the various shafts acting together (the motor shaft, the gearbox shaft and the shaft of the fin) and is very bulky not least because of the angled position of the gearbox unit (and the shaft of the fin) with respect to the electric motor. Where such an angled arrangement is not present the known solution describes and claims the use of a gearbox having epicycloidal gears, which nevertheless increase the size and dimensions of the motor-gearbox assembly, something which can give rise to problems when positioning such an electromechanical complex in a vessel.

Known solutions have a minimum number of component elements and are capable of always operating under optimum conditions; if said complexes are associated with stabilising fins, this means that operating torques can be provided over an extremely wide range, in order as a consequence to be able to drive different stabilising fins having different surface areas over correspondingly wide ranges.

In addition to this, known electromechanical complexes of the modular type substantially have all their components housed in a single housing, which is capable of being mounted on almost all vessels through very simple and quick assembly operations requiring only minimum modifications to the structure of a vessel, in particular its hull. The housing (or unit) is constructed in such a way that a motor shaft can pass through the hull of the vessel to connect to the corresponding stabilising fin.

Finally, known electromechanical complexes of the type indicated also include position sensors capable of determining spatial position in water accurately.

In known solutions, in particular those which use a “torque” electric motor, there is a problem with suitably cooling the motor and the mechanical parts connected to it in order to ensure optimum operation.

This is achieved through cooling systems of greater or lesser complexity which nevertheless alter the dimensions of the corresponding electromechanical complex and increase its costs and complexity of assembly.

These disadvantages are present in electromechanical complexes designed to control a stabilising fin. However they may also be present in electromechanical complexes designed to control any control appendage of a vessel such as a rudder.

The object of this invention is to provide an electromechanical complex for the control of a stabilising fin in a vessel of the type indicated which is capable of operating such stabilising fin (or other equivalent appendage) where the electric motor can be effectively cooled naturally by the water through which the vessel travels, in particular the water adjacent to the hull of the vessel without the need of installing complicated and costly cooling systems on the vessel.

Another object of the invention is to provide an electromechanical complex which can be cooled with minimum modifications to its structure.

A further object of this invention is to provide a cooled electromechanical complex for operating a corresponding stabilising fin (or other equivalent appendage) which increases the space available within the lower areas in the vessel itself, for example those used for accommodation.

A further object is to provide an electromechanical complex of the abovementioned type of smaller size, allowing great versatility for installation within vessels. In particular aforesaid smaller size makes it possible for several electromechanical complexes to be associated with the hull of the vessel, said electromechanical complexes being capable of controlling appendages controlling the vessel which are different from each other, such as stabilising fins and rudders.

These and other objects which will be obvious to those skilled in the art are accomplished through an electromechanical control complex for a stabilising fin of a vessel according to the principal claim.

Further characteristics and advantages of this invention will be more apparent from the following detailed description of a currently preferred embodiment thereof illustrated by way of indication, but without limitation, in the appended drawings in which:

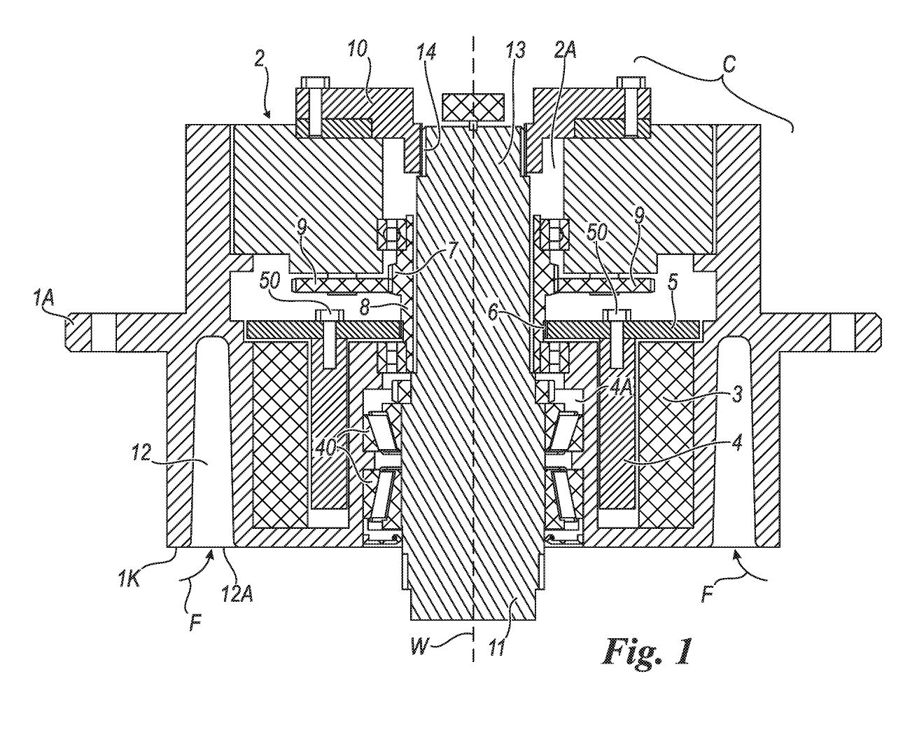

FIG. 1 is a frontal exploded view of a preferred embodiment of a mechanical control unit for a stabilising fin of a vessel according to this invention;

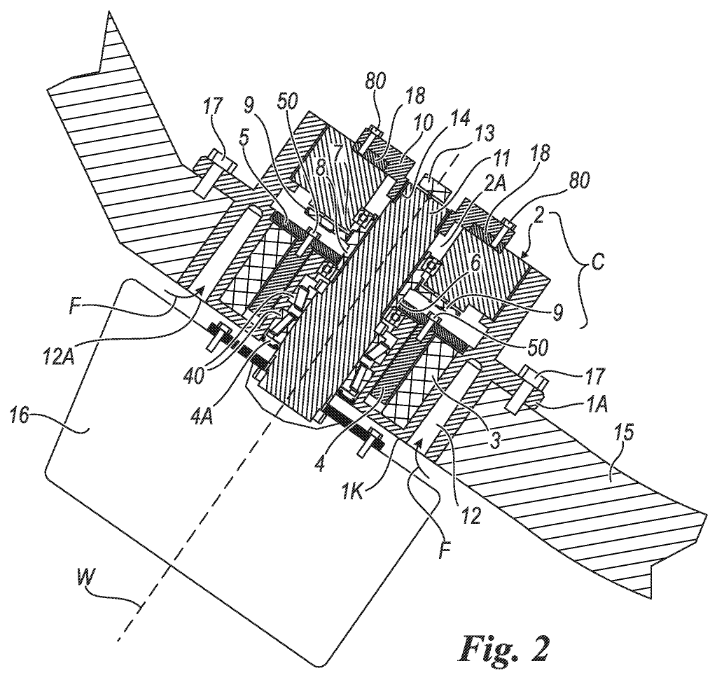

FIG. 2 illustrates an assembly diagram for the electromechanical complex in FIG. 1 connected to the stabilising fin according to this invention, in greater detail; and

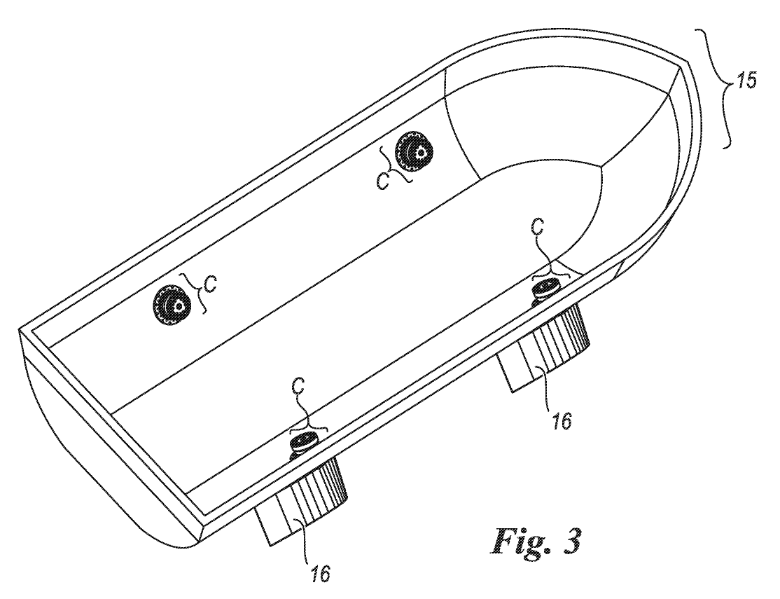

FIG. 3 shows a perspective diagrammatical view from above of the hull of a vessel provided with the electromechanical complex in FIG. 1.

With reference now to the figures mentioned, these illustrate a currently preferred embodiment of an electromechanical complex for operating a stabilising fin 16 for a vessel, the electromechanical complex being indicated in general by reference letter C. As is known, this fin is designed to stabilise rolling of the vessel as it sails, but also when it is at anchor. Aforesaid electromechanical complex is specifically designed to control the rotary motion of a shaft 11 connected to stabilising fin 16 for example through a grooved profile.

As is known, the components of electromechanical complex C are housed in a single housing or unit 1 which thus constitutes a complete and independent modular unit which can easily be installed on the desired vessel. This unit 1 is located within hull 15 of the vessel in a position close to the water line so that it can connect the electromechanical complex to the stabilising fin.

The motion and torque required by shaft 11 of fin 16 are transmitted through a gearbox 2 which is of the cycloidal type. The electric motor unit comprises a stator 3 and a rotor 4. Both said gearbox 2 and the rotor of motor 4 each delimit corresponding cavities 2A and 4A which are coaxial and placed one after the other within unit 1.

In order to obtain an electromechanical complex for controlling stabilising fin 16 of the smallest vertical dimensions possible, a motor of the “torque” type which can generate high torques useful for operating a stabilising fin 16 is used as electric motor 3, 4.

Gearbox 2 is therefore capable of increasing the torque provided by “torque” electric motor 3, 4, at the same time as reducing its angular velocity.

This motor has rotor part 4 of one piece with a flange through which the rotation of rotor 4 is transferred outside the motor. The motion is transferred to gearbox 2, as will be described.

As mentioned, gearbox 2 according to the invention is a gearbox of the so-called “cycloidal” type which in the electromechanical complex according to the invention is also coupled to a planetary gear unit. As may be seen in the figures the two fundamental components of the electromechanical complex, that is the “torque” motor and gearbox 2, are mounted coaxially, as a result of which cavities 2A and 4A bounded thereby (as mentioned above) allow shaft 11 of the fin to pass freely through them. In particular gearbox 2 is mounted above the electric motor, with reference to axis W of shaft 1 and fin 16, which is instead mounted below such motor. In this way shaft 11 can be housed between said motor and said gearbox.

As those skilled in the art will understand, this also makes it possible to house bearings 40 supporting shaft 11 of the fin within rotor 4 (which is not provided with a shaft) or within cavity 4A of the motor.

Again with reference to the figures mentioned, the manner in which the motion generated by motor 3, 4 is transmitted to shaft 11 of stabilising fin 16 will be described.

Rotor 4 is secured to flange 5 by means of bolts 50.

Through a mechanical coupling, for example a grooved profile 6 or through an interference coupling, flange 5 causes a solar pinion 8 to rotate and the latter engages with planetary gears 9 through teeth 7, thus transmitting the motion to the whole of gearbox 2.

Output of the motion from gearbox 2, which further reduces the motion, is via a rotating flange 10 which through a mechanical coupling, for example through a grooved profile 14, transmits the motion to shaft 11 of the fin. This flange 10 is attached to a ring 18 of one piece with gearbox 2 by means of bolts 80.

The electromechanical complex therefore has no shafts acting together mechanically between them (that is a motor shaft and a shaft of gearbox 2) thus allowing for the presence of cavities 2A and 4A.

A detector 13 or position sensor for shaft 11 of fin 16 must be used in order to control the electromechanical complex according to the invention.

As is known, this detector 13 is positioned at the end of shaft 11 of the fin engaging flange 10. This is possible through the fact that the electric motor and gearbox 2 are hollow and shaft 11 can therefore be freely placed through them as far as flange 10, which caused it to move. This shaft can then be coupled to detector 13 and in this way it directly detects rotation of shaft 11, in that detector 13 is directly connected to that shaft.

An appreciable disadvantage of a “torque” motor is the need for a cooling system which enables the motor to remain at the temperatures needed to prevent deterioration of the torque provided. For this reason, if no cooling is provided, motors having a high torque or power (for example 6.5 kW) more than that actually required (for example 4.5 kW) are used to move fin 16 (when this has an area of 1 m²). On heating such motors lose efficiency and the torque provided falls, but nevertheless to values which are useful for moving the fin. These motors are unavoidably of large dimensions, greater than those which a motor generating a rated torque corresponding to that needed for moving the fin would have.

For this purpose, in the state of the art such motors are cooled with water circulation systems cooled with refrigeration cycle heat exchangers.

In accordance with the invention this disadvantage is overcome through allowing the water adjacent to hull 15 of the vessel (FIG. 2) to flow freely in an annular cavity (which is continuous or defined by adjacent discrete sections which define such cavity as a whole) provided in unit 1 containing the mechanical part to cool the electric motor automatically at all times. Annular cavity 12 has at least one opening 12A below the water line of the vessel. This opening is placed at a free extremity 1K of unit 1. Said annular cavity 12 is located around at least motor 3, 4 so as to allow it to be cooled by means of the water, for example seawater, without any need to provide circuits or mechanical components specifically intended for this cooling function. Arrows F in FIGS. 1 and 2 show how water enters cavity 12.

This cooling thus takes place in a “natural” way thanks to circulation of the water on which the vessel floats and in which it is partly immersed (if the vessel is in movement) or in any event its presence within cavity 12 (if the vessel is at anchor).

This solution is readily possible due to the fact that gearbox 2 is positioned above electric motor 3, 4 (with respect to the position of fin 16).

Coupling of a flange 1A of housing or unit 1 to hull 15 by means of bolts 17 makes the electromechanical complex according to the invention to be of one piece with the vessel thus bringing about stabilisation through fin 16.

From the above it will be noted that the invention fully fulfils the tasks and objects proposed, because it specifically provides for the use of a modular complex including a minimum number of components, that is an electric motor 3, 4 mounted coaxially with the gearbox 2, both of which are hollow and contain shaft 11 of fin 16.

The gearbox is advantageously mounted above the electric motor.

Thus, as stated, shaft 11 of fin 16 passes through the entire electromechanical complex thus allowing sensor 13 which senses the position of shaft 11 of the fin to be directly mounted.

Through the invention the electric motor can be cooled naturally through contact with the water adjacent to the hull of the vessel, at the same time achieving a drastic reduction in the axial dimensions of the electromechanical complex, thus offering greater available space in the lower parts used for accommodation.

Although the electromechanical complex according to the invention has been described by making specific reference to a currently preferred embodiment, this is susceptible of many modifications and variants, all of which fall within the scope of the concept of the invention itself. For example, the case of cooling brought about by natural circulation of the water on which the vessel floats (for example seawater) within annular cavity 12 has been described. However it should be understood that this circulation may also be of the forced type, for example by means of a pump.

In particular use of the electromechanical complex to control a corresponding stabilising fin has been described. However this electromechanical complex may be associated with any control appendage of a vessel, such as the rudder.

In the practical implementation of the invention the materials used, dimensions and contingent configurations may be of any kind according to requirements.

1. Electromechanical complex for controlling a stabilising fin for a vessel, said electromechanical complex being of reduced axial dimensions and acting together with a shaft of said stabilising fin, said electromechanical complex comprising, within a single housing, an electric motor and a corresponding gearbox, said electric motor delimiting a first cavity, said gearbox delimiting a second cavity, said cavities being coaxial and placed one behind the other with respect to a longitudinal axis of the shaft of aforesaid stabilising fin, said gearbox being mounted coaxially with and above said electric motor with respect to the stabilising fin, said shaft of said stabilising fin passing through the entire electromechanical complex, passing through said first cavity and said second cavity, characterised in that said housing comprises a cavity having at least one opening located at one extremity of said housing, the cavity being located around the electric motor, aforesaid cavity being capable of receiving the water on which the vessel floats, said water cooling the electric motor.

2. Electromechanical complex according to claim 1, characterised in that said cavity is annular.

3. Electromechanical complex according to claim 2, characterised in that said annular cavity is continuous.

4. Electromechanical complex according to claim 2, characterised in that said annular cavity is defined by a plurality of discrete adjacent sections.

5. Electromechanical complex according to claim 1, characterised in that said electric motor is a motor of the “torque” type comprising a stator and a rotor, the rotor being coupled securely to first flange means rotatably activating pinion means engaging planetary gears driving said gearbox.

6. Electromechanical complex according to claim 5, characterised in that said first flange means drive said pinion means through a mechanical coupling such as a grooved profile or an interference coupling.

7. Electromechanical complex according to claim 6, characterised in that said gearbox comprises an output with further reduction through secondary rotating flange means which are coupled through a grooved profile and directly drive one extremity of said shaft of said stabilising fin.

8. Electromechanical complex according to claim 1, characterised in that said shaft of said stabilising fin supports sensor means sensing the position of said hollow shaft of said fin, said sensor means being capable of directly detecting rotation of said shaft around its own longitudinal axis.

9. Electromechanical complex according to claim 1, characterised in that, within said first cavity, bearings supporting the shaft are provided within the rotor of the electric motor.

10. Electromechanical complex for controlling a control appendage of a vessel, said appendage being a rudder or the like, said electromechanical complex being of small axial dimensions and acting together with a shaft of said appendage, said electromechanical complex comprising, included within a single housing, an electric motor and a corresponding gearbox, said electric motor delimiting a first cavity, said gearbox delimiting a second cavity, said cavities being coaxial and located one after the other with respect to a longitudinal axis of the shaft of aforesaid control appendage, said gearbox being mounted coaxially and above said electric motor with respect to the control appendage, said shaft of said control appendage passing through the entire electromechanical complex, passing through said first cavity and said second cavity, characterised in that said housing comprises a cavity having at least one opening located at one extremity of said housing, the cavity being located around the electric motor, aforesaid cavity being capable of receiving the water on which the vessel floats, said water cooling the electric motor.

11. Vessel having a hull placed on a mass of water on which it floats, said vessel having at least one stabilising fin, said fin being controlled by an electromechanical complex comprising an electric motor acting together with a gearbox to move a shaft of such stabilising fin, characterised in that said electromechanical complex is constructed in accordance with claim 1.
